(19) United States
(12) Patent Application Publication
(10) Pub. No.: US 2017/0285598 A1
(43) Pub. Date: Oct. 5, 2017

(54) SYSTEMS AND METHODS FOR MANAGING POWER GRID DEMAND

(71) Applicant: BCP CONTROLS, LLC, WACO, TX (US)

(72) Inventors: JOHN EDWARD FITCH, WOODWAY, TX (US); CHRIS SADLER, WACO, TX (US)

(21) Appl. No.: 15/509,389

(22) PCT Filed: Sep. 14, 2015
(86) PCT No.: PCT/US15/49983

§ 371 Date: Mar. 7, 2017

Related U.S. Application Data
(60) Provisional application No. 62/049,778, filed on Sep. 12, 2014.

(51) Int. Cl. G05B 19/042; H02J 13/00; H02J 3/14

(52) U.S. Cl. CPC G05B 19/042; H02J 3/14; H02J 13/0017; H02J 2003/003

(57) ABSTRACT

A method for reducing aggregate power cost that includes determining an end device power consumption profile for each of a plurality of end devices, storing the end device power consumption profiles in a switching device configured to determine a desired power flow timing for each of the plurality of end devices, determining an optimal rate period with the switching device, determining, with the switching device, the desired power flow timing for each of the plurality of end devices such that a power consumption of the plurality of end devices is preferably within the optimal rate period, and controlling, via the control device, the plurality of end devices such that the desired power flow timing is substantially obtained, thereby reducing aggregate cost per kWhr of the plurality of end devices.

### STATEMENT OF PRIORITY

The present application is a continuation of International Application No. PCT/US2015/049983, titled “Systems and Methods for Managing Power Grid Demand” and filed on Sep. 14, 2015, which claims priority to U.S. Provisional Application No. 62/049,778, titled “Method and System for Managing Grid Power Demand” and filed Sep. 12, 2014.

### TECHNICAL FIELD

The present disclosure relates to systems and methods for reducing aggregate power cost by altering device power use to preferably be during an optimal rate period.

### BACKGROUND

With the advent of smart metering enabling the measurement of a user's grid power consumption as a function of time, utility companies have been able to more accurately align consumer power billing rates to actual cost of power generation and delivery. Not surprisingly, these rates now have temporal components that vary over the short term (minutes), mid term (hours and billing periods), and long term (seasons). Consumer's rates are often based on their peak consumption during a billing period as well as their actual consumption during various peak rate periods (i.e. daily work hours vs. nighttime) and total overall consumption. Significant rate differences apply even at the hourly time period. As an extreme example, “TXU Energy Free nights (2014)” provides unlimited free energy from 10 pm to 6 am. Overall rates per kWHr may also be established based on a user's peak 15 minute consumption during the entire billing period (month/quarter). Management of consumption relative to these rate periods can provide significant cost savings without any required reduction in total kilowatts (kW's) consumed. However, current systems fail to take such a temporal component into account when determining if and when devices should be used or charged.

The combination of monitoring and controls at the individual device or fixture level, central processing capability, and temporal rate plan information would allow significant flexibility in controlling system level (billing meter) consumption to minimize cost per kwhr. Moreover, knowledge of a device's end-user's location in proximity to loads would add additional flexibility around short term peak demand by identifying additional non-critical load shedding options based on user preferences and tying a specific user to a specific demand.

Many consumer devices have inherent energy storage capacity that allows for short term operations without energy input. These include rechargeable devices such as phones (cell and wireless), laptop computers, and uninterruptable power supplies (UPS's). Other devices effectively store energy in less obvious ways such as refrigerators, hot water heaters, coffee makers. Additionally, next generation commandable lighting with dimming capabilities allows short term output reductions around overall peak demand (peak shaving) with little or no discernible change in end user experience. Any single device has minimal impact on the overall system but the combination of many small load reductions adds to a significant fraction of the instantaneous load. By Department of Energy assessments, combined plug and lighting loads can account for up to 50% of a building energy use. Thus, a pervasive problem is current systems also failing to have knowledge of a device's possible inherent energy storage, and employing such knowledge in combination with a known temporal rate plan in attempting to reduce power usage during times of high cost electricity.

Therefore, an improved system which incorporates knowledge of individual devices inherent energy storage, knowledge of rate plans and times of high cost energy, along with knowledge of a user's location as a factor as to whether and when devices may be selected to alter their storage capacity remain highly desirable.

### SUMMARY OF THE INVENTION

The present disclosure relates to systems and methods for reducing aggregate power cost by altering device power use to preferably be during an optimal rate period.

It is an object of the present disclosure to provide a system for reducing aggregate power cost, the system including a plurality of end devices, each of the plurality of end devices having a power consumption profile, and a first means for controlling power flow timing of the plurality of end devices, the first means being electrically coupled to the plurality of end devices. The system further includes a switching device having second means for determining a desired power flow timing for each of the plurality of end devices, the switching device being communicably coupled to the first means and configured for storing the end device power consumption profiles and determining an optimal rate period. The second means determines the desired power flow timing such that power consumption of the plurality of end devices is preferentially within the optimal rate period, and the first means controls power flow timing to the plurality of end devices such that the desired power flow is substantially obtained, thereby reducing aggregate cost per kWHr of the plurality of end devices.

It is another object of the present disclosure to provide a method for reducing aggregate power cost that includes determining an end device power consumption profile for each of a plurality of end devices, wherein the plurality of end devices are electrically coupled to a control device configured to control power flow to the plurality of end devices, and storing the end device power consumption profiles in a switching device configured to determine a desired power flow timing for each of the plurality of end devices, wherein the switching device is communicably coupled to the control device. The method further includes determining an optimal rate period with the switching device, and determining, with the switching device, the desired power flow timing for each of the plurality of end devices such that a power consumption of the plurality of end devices is preferably within the optimal rate period. The method further includes controlling, via the control device, the plurality of end devices such that the desired power flow timing is substantially obtained, thereby reducing aggregate cost per kWHr of the plurality of end devices.

The features and advantages of the present invention will be readily apparent to those skilled in the art upon a reading of the description of the preferred embodiments that follows.

### BRIEF DESCRIPTION OF THE DRAWINGS

The following figures are included to illustrate certain aspects of the present invention, and should not be viewed as an exclusive embodiments. The subject matter disclosed is capable of considerable modification, alteration, and equivalents in form and function, as will occur to one having ordinary skill in the art and the benefit of this disclosure.

FIG. 1 is a block diagram of a system for determining and controlling power to end devices, according to one or more embodiments.

FIG. 2 is a block diagram of a control device for controlling power flow to end devices, according to one or more embodiments.

FIG. 3 is a block diagram of a switching device for determining a desired power flow timing for end devices, according to one or more embodiments.

FIG. 4 depicts a graph of an example power consumption profile for an end device containing a rechargeable battery, according to one or more embodiments.

FIG. 5A and FIG. 5B depict graphs related to a power consumption profile for an end having thermal energy storage, according to one or more embodiments.

FIG. 6A and FIG. 6B depict flow diagrams for determining a desired power flow timing for end devices related to demand response or peak shaving, according to one or more embodiments.

FIG. 7 is a graph depicting aggregate usage and peak demand periods of a plurality of end devices, according to one or more embodiments.

FIG. 8A and FIG. 8B depict flow diagrams for determining a desired power flow timing for end devices related to knowledge of temporal pricing patterns.

FIG. 9 is a graph of an temporal pricing pattern, according to one or more embodiments.

### DETAILED DESCRIPTION

The present disclosure relates to systems and methods for reducing aggregate power cost by altering device power use to preferably be during an optimal rate period.

As used herein, a “processor” may be comprised of, for example and without limitation, one or more processors (each processor having one or more cores), microprocessors, field programmable gate arrays (FPGA's), application specific integrated circuits (ASICs) or other types of processing units that may interpret and execute instructions as known to those skilled in the art.

As used herein, “memory” may be any type of storage or memory known to those skilled in the art capable of storing data and/or executable instructions. Memory may include volatile memory (e.g., RAM), non-volatile memory (e.g., hard-drives), or a combination thereof. Examples of such include, without limitation, all variations of non-transitory computer-readable hard disk drives, inclusive of solid-state drives. Further examples of such may include RAM external to a computer or controller or internal thereto (e.g., “on-board memory”). Example embodiments of RAM may include, without limitation, volatile or non-volatile memory, DDR memory, Flash Memory, EPROM, ROM, or various other forms, or any combination thereof generally known as memory or RAM. The RAM, hard drive, and/or controller may work in combination to store and/or execute instructions.

Referring now to the drawings, wherein like reference numbers are used herein to designate like elements throughout the various views and embodiments of a unit. The figures are not necessarily drawn to scale, and in some instances the drawings have been exaggerated and/or simplified in places for illustrative purposes only. One of the ordinary skill in the art will appreciate the many possible applications and variations based on the following examples of possible embodiments. As used herein, the “present disclosure” refers to any one of the embodiments described throughout this document and does not mean that all claimed embodiments must include the referenced aspects.

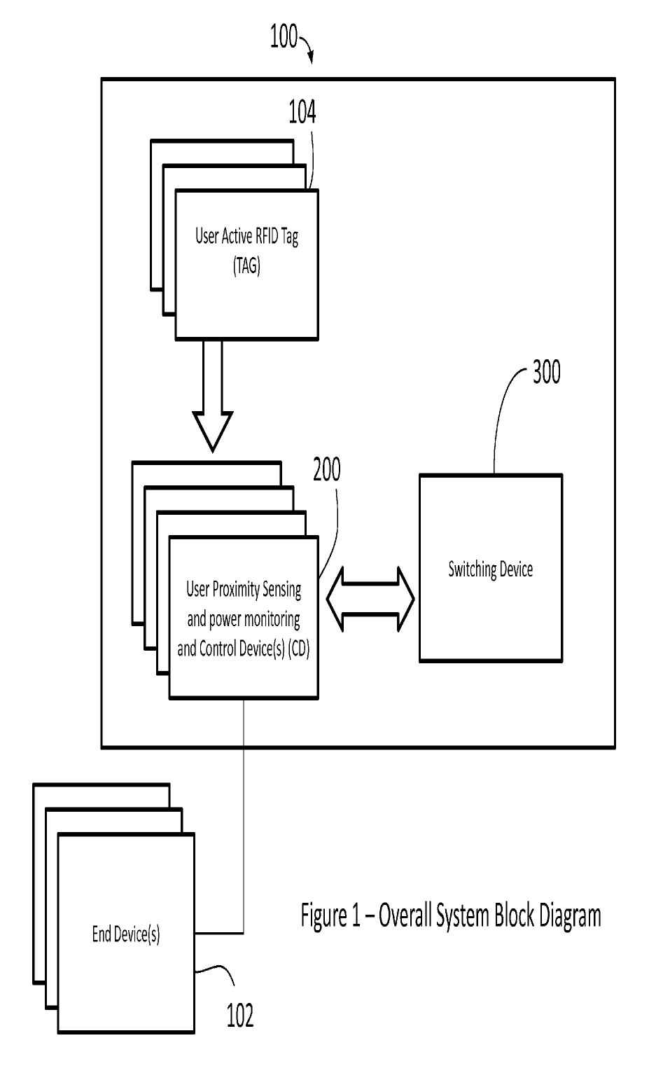

FIG. 1 is a block diagram of a system 100 for determining and controlling power to end devices, according to one or more embodiments. As depicted, the system 100 includes one or more end devices 102. Example end devices 102 may be, for example and without limitation, pluggable electrical devices, permanently installed switch controlled electrical devices, permanently installed sensor controlled electrical devices, or individually controlled lighting fixtures. Some of such end devices 102 may be capable of storing energy in various ways. For example, some end devices 102 may include a rechargeable battery, such as a laptop. However, other end devices 102, such as a refrigerator (or home or building), may store energy in the form of thermal energy, where an area or space is maintained at a certain temperature (cold or hot).

The system 100 further includes a control device 200 electrically coupled to one or more of the end devices 102, thereby being capable of controlling power to the end devices 102, including how much power is delivered to the end devices 102 and how often (e.g., power flow timing). In some embodiments, the control device 200 is further capable of performing proximity sensing, such as sensing an active RFID tag 104 having a unique ID and being associated with a user or a user device. In further embodiments, the control device 200 additionally or alternatively is capable of monitoring the power required or drawn by the device 102, thereby enabling the system 100 to log a history of such and determine a power consumption profile for each end device as will be discussed in more detail below.

The system 100 further includes a switching device 300 for determining a desired power flow timing for the end devices 102. The switching device 300 is communicably coupled to the control device 200, thereby enabling communication to the control device 200 to apply the desired power (including power level) to the end devices. In sum, the switching device 300 monitors the end devices 102 power usage and time of usage (via the control device 200, thereby enabling determination of end device power consumption profiles, calculation of instantaneous power usage, and prediction of future energy peaks. In some embodiments, the switching device will employ such information to alter when end device power usage occurs to avoid or reduce peak energy usage. In other embodiments, the switching device 300 further includes temporal (hourly) rate information which can be further incorporated into when end devices use power, such as shifting power (if possible) to time of lower cost energy.

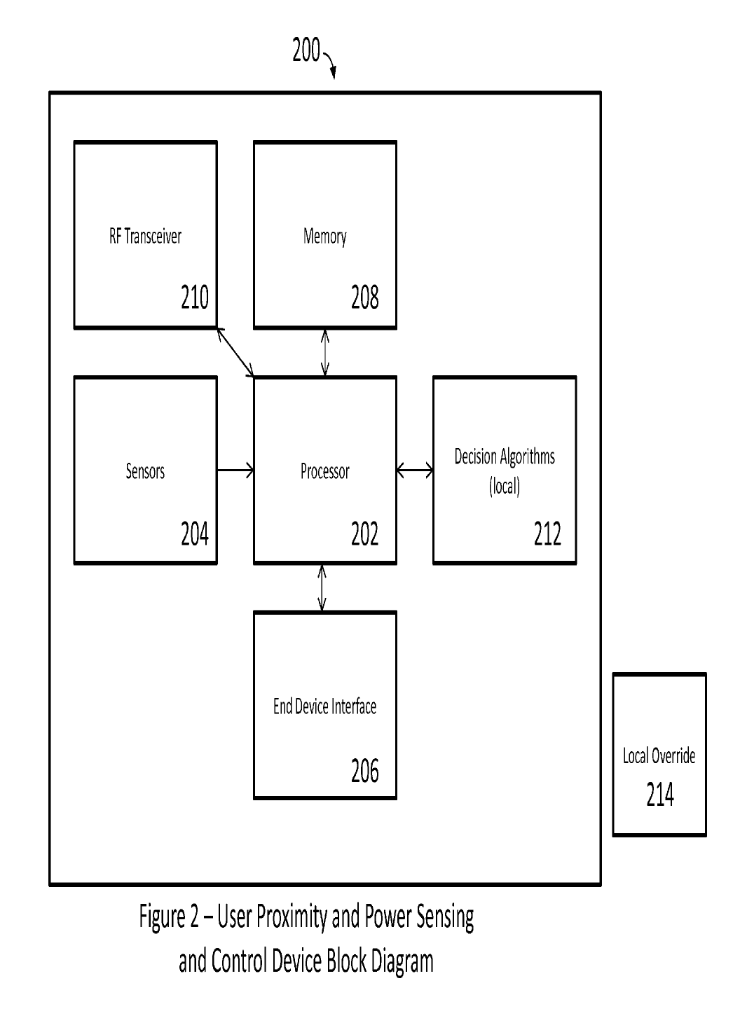

FIG. 2 is a block diagram of the control device 200 for controlling power flow to end devices 102, according to one or more embodiments. As depicted, the control device 200 includes a processor 202, sensors 204, an end device interface 206, and control device memory 208.

The end device interface 206 is electrically coupled to the end devices 102 for monitoring and/or control thereof. More specifically, the end device interface 206 may act as a power control circuit and be used to adjust, interrupt, disrupt, and/or allow power to the end devices 102. As will be described in further detail herein, the end device interface can be controlled either by the processor 202 or from a local override 214. The end device interface is capable of outputting various signals to each end device 102, such as a 0-10v signal, a pulse width modulation (PWM) signal, or other signals known to those skilled in the art.

The sensors 204 can be, for example and without limitation, current sensors, power sensors, temperature sensors, motion sensors, radiation sensors, or other sensors, and can have a digital or analog interface to the processor 202. The processor 202 may obtain end device characteristics via the sensors 204, such as the time and duration the end devices 102 are employed (e.g., in use; charge time; on/off time; amount of power being used), thereby enabling determination of a power consumption profile. Such end device characteristics and/or power consumption profile may be stored in the memory 208 for later recall.

In some embodiments, the control device 200 may further include an RF transceiver 210. Such may be used in isolation, or in combination with the sensors 204, for detecting whether a person is using an end device or within an effective use range (e.g., within a certain distance to lights, or within a particular zone for heating and air conditioning). Such knowledge may be obtained by receiving or detecting an RF signal from a user device associated with the user.

In other embodiments, the user's RFID tag may be an active RFID tag, in which case a user's distance from end devices 102 may be determined via the received signal strength indication (RSSI) of the RFID tag as known to those skilled in the art. The RSSI value allows a rough estimation of proximity between numerous control devices 200 and the RFID tag. Knowledge of control device 200 location in a facility and relative to other control devices 200 may allow a rough triangulation of the user location if at least two control devices 200 heard the tag at the same relative time. In one exemplary embodiment, RFID tag transmission may be approximately every 4-5 seconds. In another embodiment, communication between the RFID tags and the control devices 200, and between the control devices 200 and the switching device 300 are in point to point non networked fashion. That is, each device transmits and receives in an asynchronous, blind manner with no real time network handshake confirming receipt of the data.

The RFID tag may additionally have a microcontroller, and/or sensors, and/or local memory. In one embodiment, the active RFID tag goes from a sleep mode to a wake mode approximately every 4 seconds. In wake mode the RFID tag transmits a unique tag identification number. The tag may additionally transmit a current battery level, and returns to sleep mode. No acknowledgement of receipt of information is made from the control device 200 to the RFID tag. In a sense, it is a ‘dumb’ asynchronous transmitter. In further embodiments, the RFID tag and/or the system 200 utilizes a smart phone device with a blue tooth transmitter to transmit the MAC address of the smart phone but not establish a pairing. Thus, again, transmitting a unique user device ID. The switching device 300 may store the unique user device's ID (e.g., either the RFID tag or unique ID of the phone), either in memory or a database, along with the user's associated power preferences that should be initiated when the unique user device ID is detected.

With knowledge of an end device's 102 power usage and/or power consumption profile, the processor 202 may employ control device decision algorithms 212 (possibly stored in the memory 208) to determine the power to each end device. As discussed above, the control device decision algorithms 212 may further account for a person's location and alter power to the end device accordingly to accommodate devices which may affect the person, for example, lights, air conditioning, or power to a computer. Moreover, in other embodiments, such control device decision algorithms 212 may further account for critical end devices by not reducing or eliminating power therefrom in order to assure safety and critical systems are not rendered dysfunctional. In some embodiments, the control device 200 and/or control device decision algorithms 212 may work in combination with the switching device 300 and/or algorithms implemented therein to determine end device power implementation and utilization.

The local control device decision algorithms 212 can be either control algorithms for power output to the end devices 102, or algorithms for properly interpreting the sensor 204 data such as a peak detection algorithm or integration algorithm. These are considered local control algorithms because they do not require information from the switching device 300 in order to function. In one embodiment, these local algorithms 212 determine the priority from various sensors 204 and user RFID tags to determine which end device 102 to power, and how much power to provide. In general, the control device 200 operates in a hybrid control fashion, with most short term decisions being made locally, but in the context of the aggregate system as determined by the switching device 300.

The following exemplifies why unique user device ID's (e.g., either the RFID tag or unique ID of the phone) may be advantageous. For a lighting example, the local decision algorithm 212 of the control device 200 may set the load of multiple overhead lights (end devices 102) to 50% based on sensing the proximity of a user's RFID tag that has that preference for light level. When a second higher priority RFID tag enters the area, the control device 200 may set the same connected lighting load to 85%. If both users remain in proximity for some time, the local decision algorithm 212 may decrease the load to 75% over time. In this example, these are normal set points controlled locally by the control device 200. However, in the context of the overall system, if the switching device 300 identifies a need to reduce power around a peak demand or a demand response request for a brief period of time, the switching device 300 may temporally reduce the set points in the example above by a small percentage to offset the peak demand.

In further embodiments, a local override 214 may be employed (in hardware (e.g., a switch) and/or software). The local override 214 is configured to override signals or determinations from the processor 202. Such may be advantageous, for example, if the person has different preferences as compared to the pre-programmed control device decision algorithms 212. For example, the person may prefer additional lighting, or may need power to additional end devices to enable maximum efficiency while working, such as power to a coffee maker or altering the thermostat, thereby requiring power to heat or air condition a particular space.

In one embodiment, some or all of the control device 200 components may be implemented as a “system on a chip” (SOC) as known to those skilled in the art. The SOC may provide an analog and/or digital interface to the sensors 204 and allow communication between any of the components of the control device 200, and between the control device 200 and external devices, such as the switching device 300.

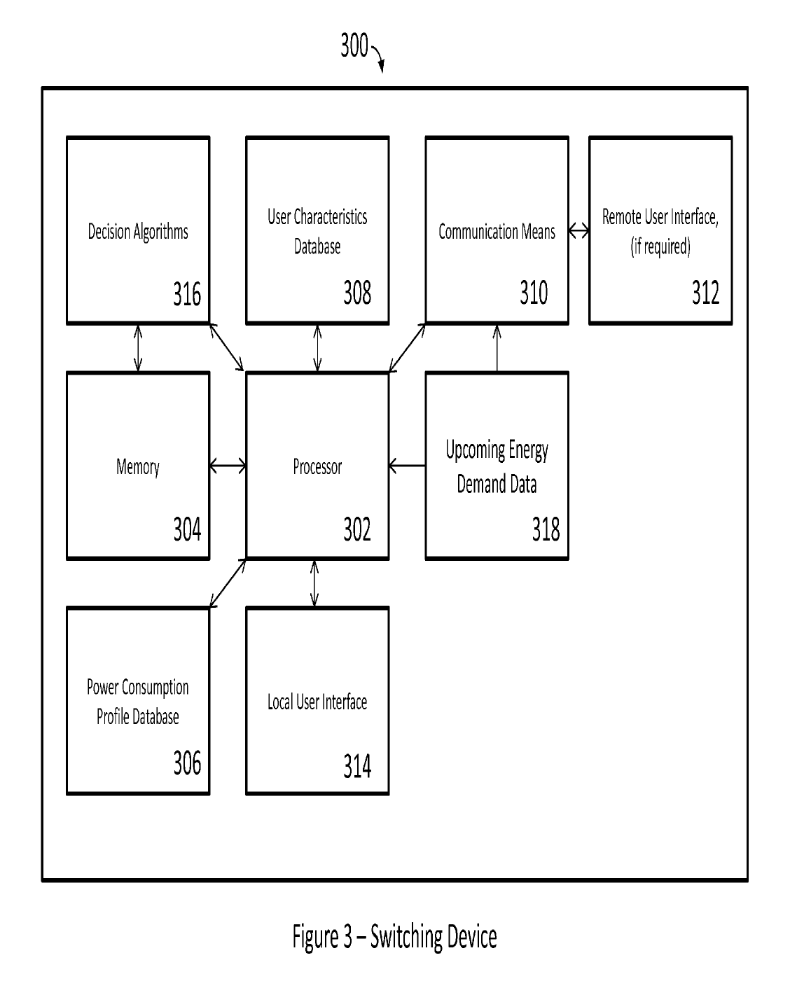

FIG. 3 is a block diagram of a switching device 300 for determining a desired power flow timing for end devices 102, according to one or more embodiments. The switching device 300 is communicably coupled to the control device 200, thereby enabling the switching device 300 to make decisions regarding end device 102 power usage and utilization and relay those decisions to the control device 200 for implementation. Of course, as discussed above, such decisions may also be made in combination with the control device 200.

As depicted, the switching device 300 includes a processor 302 and a memory 304. The memory may be employed to, among other things, store end device power consumption profiles determined by the processor 302 and/or determined by the control device 200. Moreover, the power consumption profile may be stored in a power consumption profile database 306, as may similarly be a user characteristics database 308 storing a history of the user's characteristics, such as their typical location (relative to end devices) and time of using end devices 102. Those of skill in the art will appreciate that while the power consumption profile database 306 and user characteristics database 308 are depicted individually, such may be implemented and/or stored in the memory 302 of the switching device 300, or alternatively stored in memory external to the switching device 300 but communicably coupled thereto (e.g., other computing devices, servers, on a “cloud network,” etc.). The databases may be implemented by any technology known to those skilled in the art, for example and without limitation, such as SQL.

The switching device 300 may communicate with the control device 200, and any other computers, databases, and/or the internet via a communication means 310, such as an RF transceiver or network communication card (wired or wireless), or other communication methods as known to those skilled in the art. In one exemplary embodiment, power usage and user proximity information are transmitted every 10 seconds with a +/−2 Watt resolution. The communication means 310 may further be employed for an administrator to access the switching device via a remote user interface 312 as known to those skilled in the art. Alternatively, or in addition thereto, a local user interface 314 may be employed.

Decision algorithms 316, discussed in further detail below, may be stored in the memory 304 and executed by the processor 302 to determine the timing and power which should be provided to each end device 102. The decision algorithms 316 may incorporate an upcoming energy demand data 318, either as indicated by a power company (e.g., as communicated via the communication means 310 to the switching device) or as predicted by the processor 302. Alternatively, the memory 304 may have knowledge of the user's rate plan, which can include a rate which changes to a known cost for each hour of the day, and determine end device power at least partially based thereon.

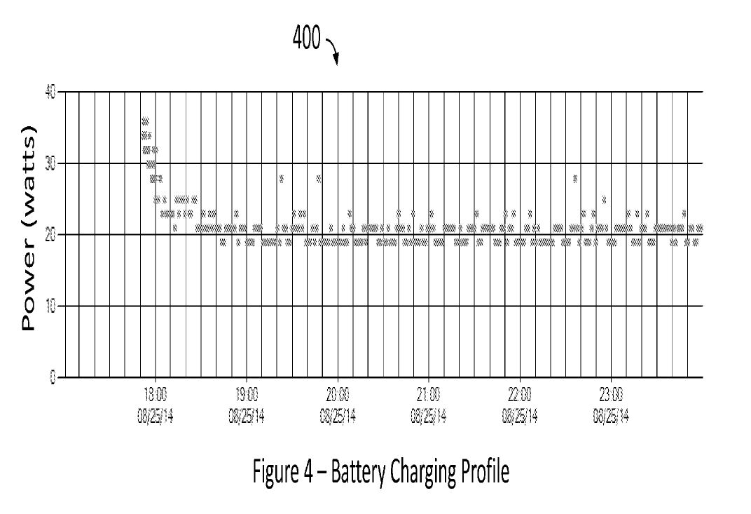

FIGS. 4-6 show various embodiments of end device 102 power consumption profiles, including charging characteristics and power usage profiles.

FIG. 4 depicts a graph 400 of an example power consumption profile for an end device containing a rechargeable battery (e.g., a laptop), according to one or more embodiments. Such a power consumption profile may be stored in memory 304 and/or the power consumption profile database 306 and employed by the decision algorithms 316 via the processor 302 when deciding which end device 102 to turn on and when.

The graph 400 shows the power drawn by the laptop as a function of time. A discharged battery is allowed to recharge, which initially draws approximately 37 watts as seen at the time of approximately 18:00 hours. Over the course of approximately 20 minutes, the power draw comes to the fully charged nominal power draw of approximately 20 watts. The device substantially maintains the nominal power draw of approximately 20 watts for the remainder of time. This power consumption profile is typical for battery systems. The current embodiment allows values to be set for each device that identify if the device is fully charged, charging, or discharged. The percent of charge can be established based on the average value of the power drawn at a given time. Once the percent of charge is determined, a corollary relationship exists for the available discharge time. This relationship can either be established through an automated charge discharge cycle while being monitored (e.g., by the control device 200) or entered as a table into the memory 304 and/or power consumption profile database 306 based on the device specifications and characteristics. In some embodiments, table may include a knock down factor for battery aging from the time the device is initially entered into the database.

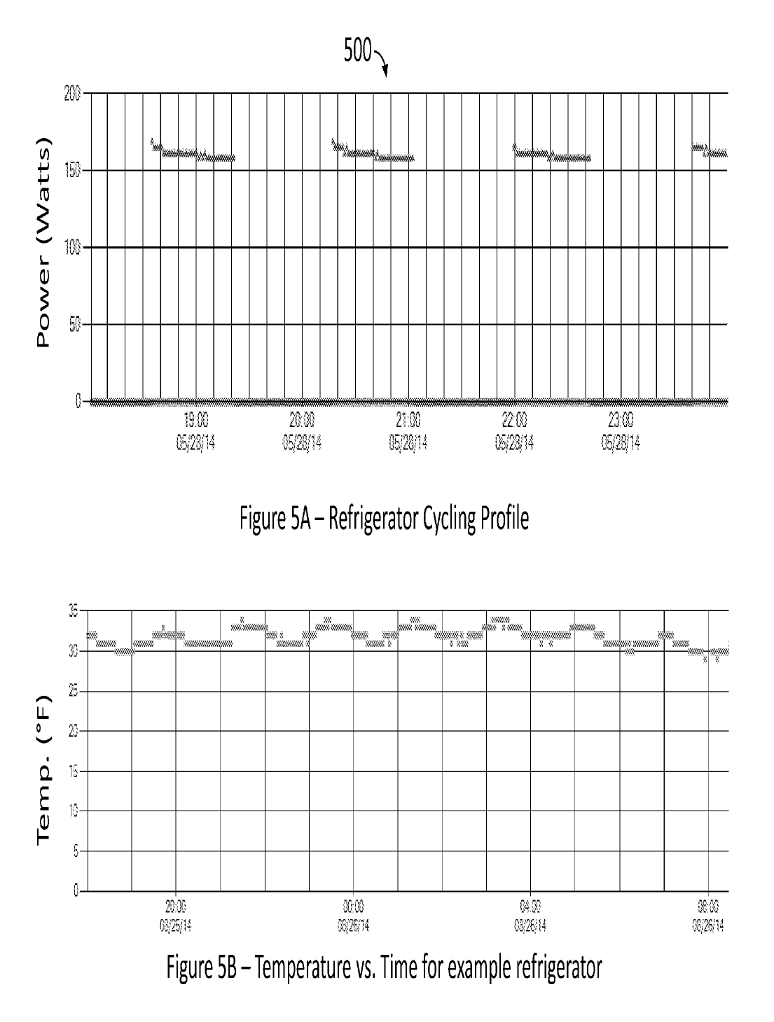

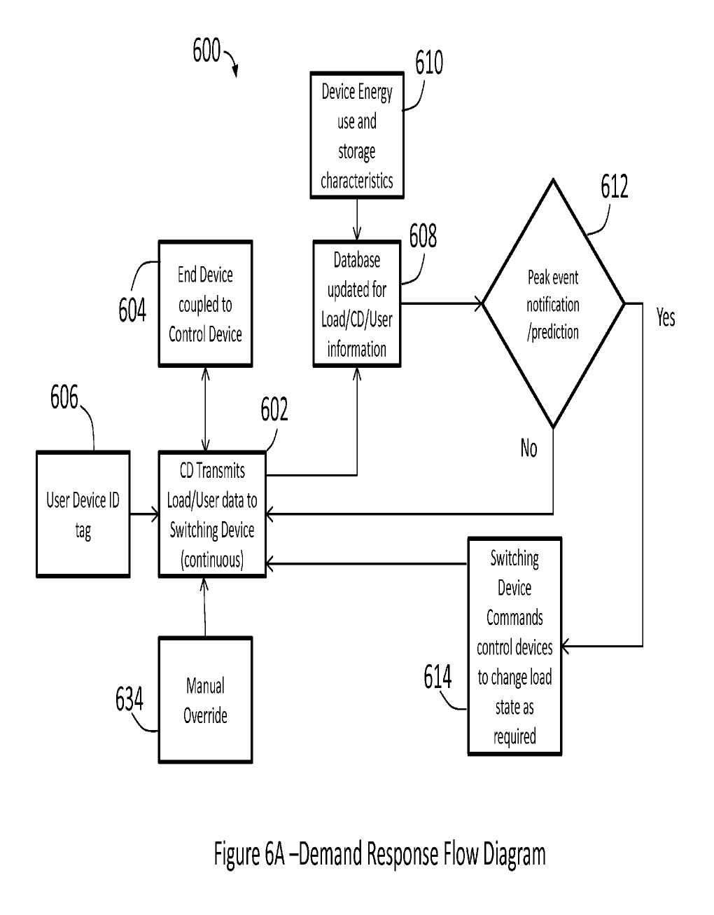

FIG. 5A and FIG. 5B depict graphs related to a power consumption profile for an end device 102 having thermal energy storage, according to one or more embodiments. FIG. 5A is a graph 500 having a power consumption profile for a refrigerator, which stores thermal energy via the temperature of the refrigerator and/or freezer. Without power, the thermal energy decreases (i.e., the temperature inside the refrigerator slowly increases over time) and eventually the refrigerator needs power to cool the temperature back down to the desired temperature.

The graph 500 illustrates the power drawn by the end device 102 refrigerator as a function of time showing a cycling of approximately 45 minutes in the “on” state (drawings power to cool the refrigerator), followed by approximately 55 minutes in the “off” state (not drawings power). During the on period of the cycle, the power draw is approximately 160 watts on average. Using the characteristics of the refrigerator data or the specifications from the manufacturer (e.g., as may be obtained online or be stored in memory 304), a time versus temperature profile can be established for the power off ‘discharge’ of stored thermal energy in the refrigerator. The switching device 300 can determine the thermal state of charge from the near term historical data and can predict how long the end device 102 can remain off with no impact to the user. Knowledge by the switching device 300 of a device's immediate power storage capacity is critical to the control algorithms identified. If desired, a temperature sensor can also be added to the control device 200 to show temperature versus time for power on versus power off state. An example of this is shown in FIG. 5B for the same mini refrigerator data shown in FIG. 5A.

An alternate method for calculating storage capacity for an end device 102 is to use limits on the monitored power of a device to establish various charging states. Using the above refrigerator example again, there are only 2 states, on and off as shown in FIG. 5A. Knowing the nominal power on state is 45 minutes and the nominal power off state is 55 minutes. The switching device 300 can determine the number of minutes above the power on threshold during the past 45 minutes then divide by 45 minutes. If the device had been on for the past 45 minutes it is fully charged. If it had been off for the past 45 minutes it is effectively fully discharged. Each end device 102 would have a similar calculation based on its charging and discharging characteristics. These characteristics may be held in memory 304 and/or the end device power consumption profile database 306.

As will be discussed in detail below, knowledge of such power consumption profiles allows the switching device 300 to accurately estimate at what time each end device may require power, thereby enabling the switching device to alter the time of charge of the end device to a time which has a lower electricity rate, or avoid peak power demands, in either case reducing the aggregate power cost of the system.

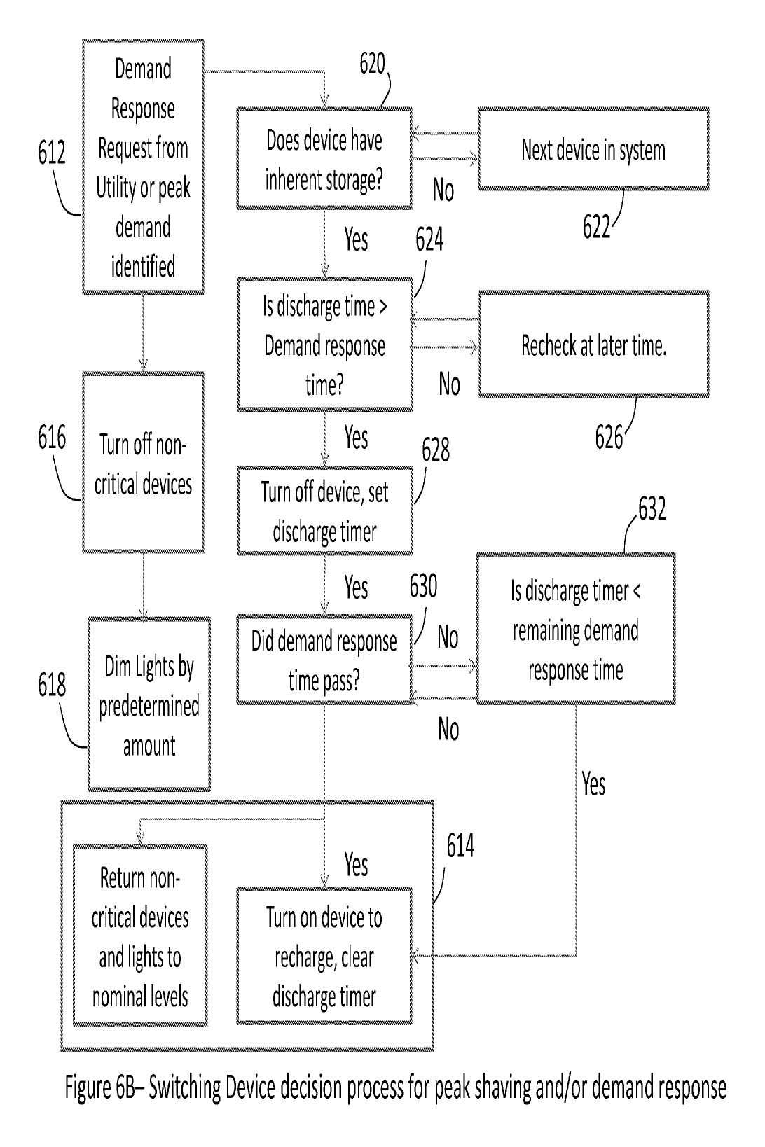

FIG. 6A and FIG. 6B illustrate flow diagrams for determining a desired power flow timing for end devices related to demand response or peak shaving, according to one or more embodiments. In sum, upon the switching device obtaining notification from a utility provider that an impending power peak is approaching or currently occurring (either for the facility, or possibly city wide), or the switching device determining the same for the facility, the switching device determines an optimal rate period (e.g., a time during the day other than peak usage time). Thereafter, the switching device will further determine a desired power flow timing, which is the timing of power flow to be reduced or eliminated to some or all of the end devices. With some caveats below (e.g., critical devices, required charging, and/or override ability), such will be disseminated to the control device for implementation, thereby reducing peak usage, in turn reducing cost.

Turning now to FIG. 6A, as depicted at block 602, the control device is electrically coupled to the end device at block 604, thereby enabling monitoring of the end device load, and also control of power to the end device. The control device is also capable of detecting where a user may be located via the unique user device ID tag (e.g., an active RFID tag or cell phone) associated with the user, as at block 606.

The control device communicates such information to the switching device at block 608. The switching device may determine end device power consumption profiles and/or storage characteristics (either via monitoring the end device, previously stored data, and/or manual input, for example, based on manufacturer specifications), as at block 610.

Typical demand response periods are measured in a few hours. (i.e. 4 pm-6 pm). In a typical demand response scenario, the utility provider identifies a high overall aggregate demand on their generating capacity leading to a potential brown out or black out situation if aggregate demand is not reduced. Large energy users typically have a clause in their energy contracts that provide significant financial incentives for each kWHr reduction during an identified demand response period. Therefore, if there is not a peak event notification (from the power company) or prediction (e.g., based on knowledge of users regular habits and routines, stored information regarding end device power consumption profiles, and/or current aggregate load), the switching device may not alter any power change to the end devices. However, if there is a peak event notification or prediction as at block 612, the switching device may determine an optimal rate period in which end device power should be altered to be within in order to reduce such a peak energy usage. Thereafter, the switching device may determine what reduction in power to apply to each end device to be within the optimal rate period, as at block 614.

Briefly turning to FIG. 6B, depicted is a flow diagram for determining desired power flow timing for end devices, according to one or more embodiments. Again, at block 612, the switching device either receives a peak event notification from the power company or predicts a peak event based on knowledge of the end devices and their power consumption profiles. In one embodiment, the switching device may command that all non-critical devices be turned off, as at block 616, and the lights be dimmed by a predetermined about (e.g., between 10% and 35%), as at block 618. In one embodiment, such decisions on which end devices to turn on or off, or how much power to reduce to an end device may be at least partially based on a user's location based off a user device (e.g., RFID tag or cell phone). Additional commands may be to turn off all fully charged devices, along with refrigerators and hot water heaters. Such may be performed by the switching device sending a single signal to the control device, or alternatively by the switch device sending a plurality of signals to the one or more control devices coupled to the end devices.

At block 620, the switching device begins the cycle to determine if devices with inherent energy capabilities can be turned off or not. Again, such may include devices that have a rechargeable battery, but also other devices, such as a refrigerator having thermal energy storage. At block 622, if the end device has no inherent energy storage capabilities, the system may move on to the next end device. At block 624, the switching device determines if an end device's discharge time is greater than the demand response time—in other words, can the end device maintain a charge for a period longer than the demand response time (or predicted demand response time)? If not, the end device power may not be altered in order to allow the end device to further charge and the system may check again later as at block 626. Otherwise, if it is determined the end device has a charge that will enable the end device to maintain power past the end of the demand response time, the switching device may determine the desired power flow for that device to be zero (turn power off) and set a discharge timer, as at block 628.

At block 630, the switching device checks to see if the demand response time has passed. In combination therewith, at block 632, the switching device checks to see if the discharge timer of the end device is less than the remaining demand response time as this may continuously change. If so, than the end device will run out of power prior to the demand response time ending and the end device should be turned on and charged as at block 614. If not, then the switching device continuously loops between blocks 630 and 632 until the demand response time has passed, in which case lights are returned to nominal levels and non-critical devices begin charging again.

Returning now to FIG. 6A, in further embodiments, a manual override may be employed as at block 618, thereby overriding any command from the switching device to change power to one or more of the end devices.

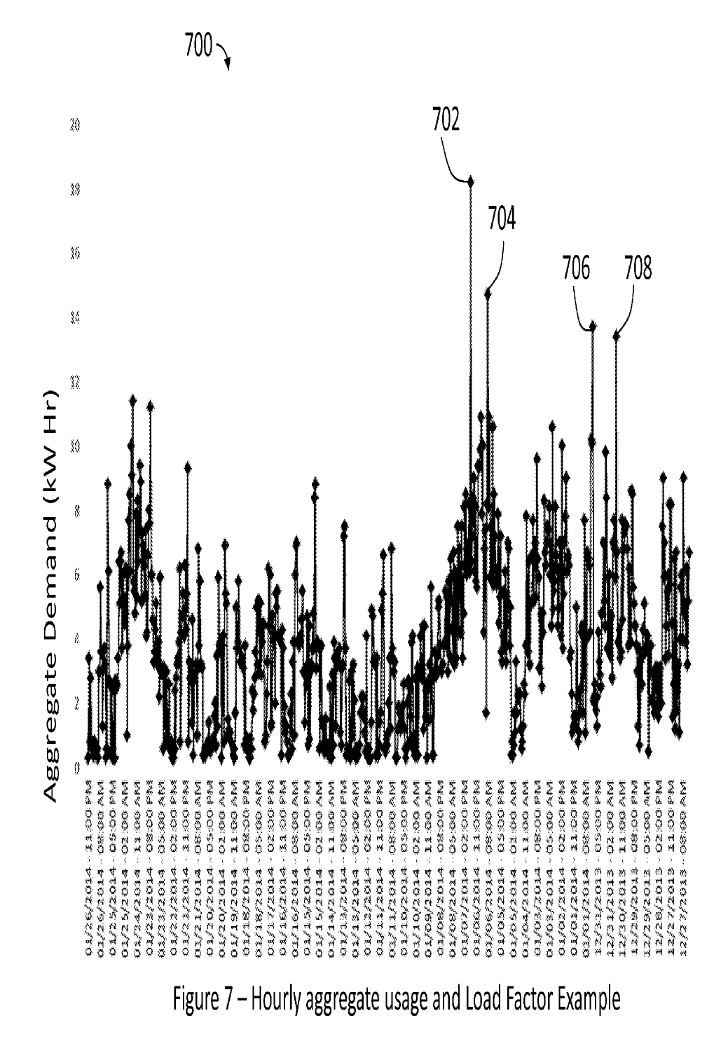

FIG. 7 is a graph 700 depicting aggregate usage and peak demand periods of a plurality of end devices, according to one or more embodiments. Utility companies set rate structures on a number of factors including the peak load required by a customer during any measurement cycle in a billing period. (Typically every 15 minutes to 1 hour). Typically, the higher the peak demand, the higher the cost per kWHr as the utility must be able to provide that peak demand at any given time. Load factor is typically defined as the average load (KWHr) during a billing cycle divided by the maximum load during a billing cycle. A load factor of 100% states that the average load is the same as the maximum load. A load factor of 10% states that the average load is only 10% of the peak load. A high load factor optimizes the cost per kWHr for a consumer. FIG. 7 shows a detailed example of data taken hourly at an aggregate (billing meter) level for one month. The peak demand for the period is approximately 18 kW as depicted at point 702, with an average load of 3.6 kW and a monthly usage of 2592 kWHr resulting in a load factor of 0.20 or 20%. Four events (out of 720 or 0.5%) which produced a peak between 12 kW and 18 kW were recorded during this period, depicted at points 702, 704, 706, and 708. Employing the systems and methods described herein, changing demand during these 4 events would have a potential to increase the billing period load factor from 0.2 to 0.3 or 30%, thereby decreasing overall cost.

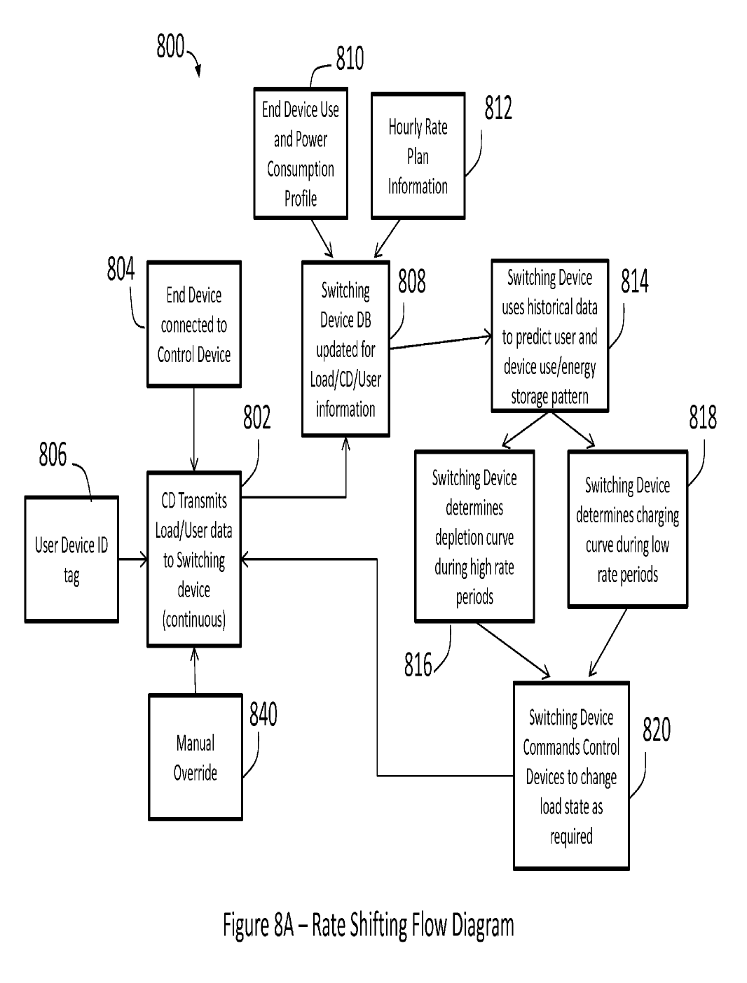

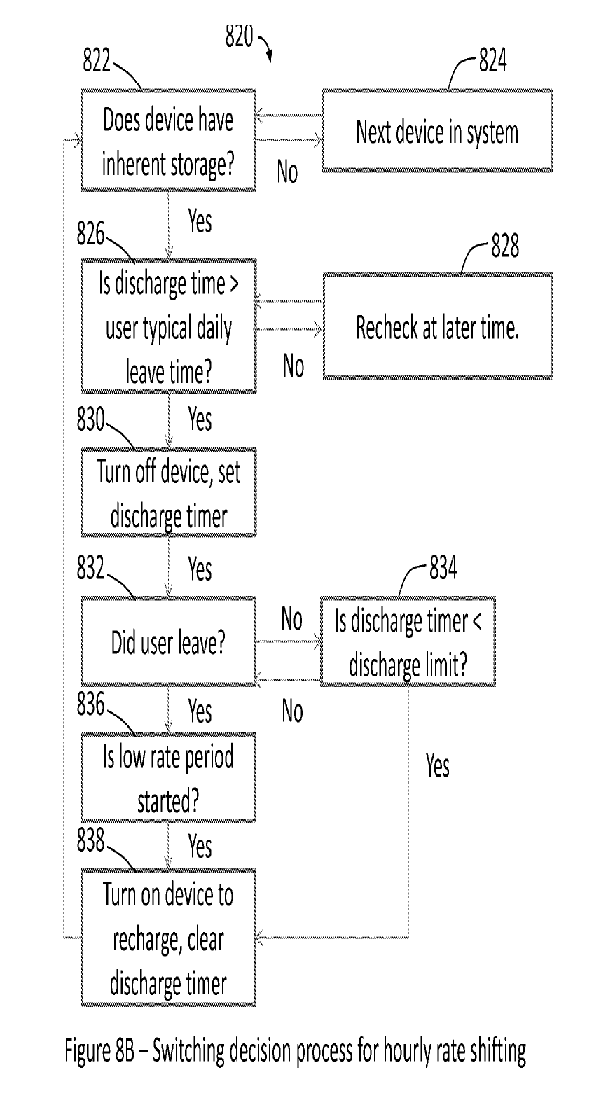

FIG. 8A and FIG. 8B depict flow diagrams for determining a desired power flow timing for end devices related to knowledge of temporal pricing patterns (“rate shifting”). In sum, the switching device has knowledge of a temporal pricing pattern, and can determine an optimal rate period for charging end devices (e.g., some period of time other than one at which the rates are their highest). The switching device can thereafter determine when and how much power should be applied to the end devices to shift power usage to this optimal period, thereby decreasing overall cost. The control device may then substantially implement the switching device's decision. For example, if a rate plan's highest charges are at 4 pm, the optimal rate period may be any time other than 2 pm-4 pm, thus the switching device algorithms would attempt to shift power to the end devices to the optimal rate period to decrease cost. This concept is discussed in further detail below.

The flow diagram 800 of FIG. 8A is substantially similar to the flow diagram 600 of FIG. 6A, and therefore some elements will not be repeated in detail. As depicted at block 802, the control device is electrically coupled to the end device at block 804, thereby enabling monitoring of the end device load, and also control of power to the end device. The control device is also capable of detecting where a user may be located via the user ID tag (e.g., an active RFID tag or cell phone) as at block 806.

The control device communicates such information to the switching device at block 802. The switching device may determine end device power consumption profiles and/or storage characteristics (either via monitoring the end device, previously stored data, and/or manual input, for example, based on manufacturer specifications), as at block 810. The switching device (and/or database(s) associated therewith) further includes hourly rate plan information, such as at block 812.

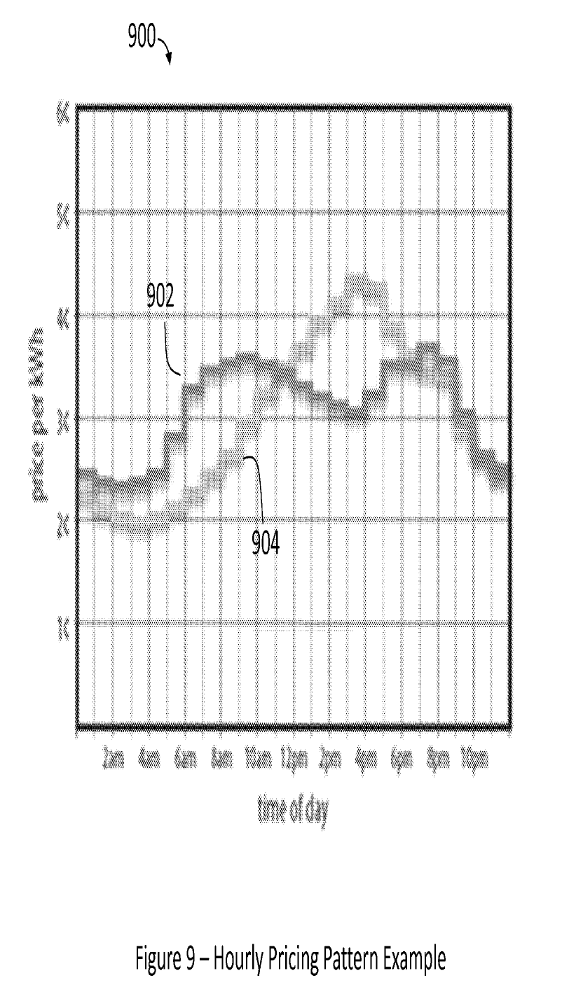

Briefly turning to FIG. 9, depicted is a graph 900 of a temporal pricing pattern, according to one or more embodiments. Graph 900 is a time versus price per kWh graph which depicts the energy price changing each hour. Moreover, the graph 900 includes a seasonal component as a first rate pattern 902 for pricing for fall, winter, and spring, and a second rate pattern 904 having different pricing for summer. As easily visualized the cost per kWHr is substantially higher at some points during the day, such as in the second rate plan 904, the cost peaks at approximately $0.0425 per kWHr from approximately 3 pm to 4 pm. Thus, charging a battery at 4 am, when the cost is approximately $0.02 per kWHr, could result in approximately a 50% cost savings, without reducing the total kWs used. Other rate plans (not depicted) may offer different temporal components, such as mornings (defined as 6 am-2 pm) may cost $0.059 per kWhr, whereas evenings and nights (2 pm-6 am) cost an increased $0.118 per kWHr.

Referring now back to FIG. 8A, again, the user or company's temporal rate plan (e.g., hourly rate plan) is stored in the switching device as at block 812. In one embodiment, the switching device may use historical data to predict user end device use and energy storage patterns, as at block 814. Moreover, in further embodiment, the switching device may additionally or alternatively determine a depletion curve based on historical usage and/or the power consumption profile of the end device, as at block 816. Similarly, the switching device may determine a charging curve during low rate periods, as at 818.

At block 820, the switching device determines what power changes to apply to each end device. Turning now to FIG. 8B, illustrated is a detailed flow diagram of block 820. More specifically, in determining an end device power change, if any, the switching device may first detect if the end device has inherent energy storage, as at block 822. Such may include end devices that have a rechargeable battery, but also, for example, devices such as a refrigerator which have thermal energy storage. At block 824, if the end device has no inherent energy storage capabilities, the system may move on to the next end device.

At block 826, the switching device determines if the end device discharge time is greater than when the user typically leaves a particular area or leaves work. If not, the end device charge may be constantly rechecked at a particular interval, such as at block 828. If so (if the device can hold power beyond when a user typically leaves work), power to the device may be reduced or eliminated if such a time is a higher cost (e.g., evening time) than otherwise (e.g., midnight or early morning) to charge the end device, as at block 830. Beyond merely determining if the storage can last beyond when the user is supposed to, or predicted to leave work, a confirmation step that the user actually left is also employed, such as at 832. If the user is still at work, and the end device discharge is predicted to fall below a predefined limit, the end device may be powered on to allow charging, such as at block 834. If the user has left work, block 836 checks to see if a low-rate period has started. If so, the end device may be turned on for charging, such as at block 838.

In one example, the switching device may predict potential savings and commands the laptop power off at 2:30 pm. A discharge timer is set to track the state of discharge of the device. In a normal pattern, the user continues working on battery power from 2:30 to 4:30 pm at which point the laptop goes to sleep mode due to inactivity when the user leaves. At approximately 4 am, the laptop is tuned on to fully recharge during the minimum cost period so that it is fully charged when the user returns at 8 am. If the user does not leave at a typical time, the system may, for example, use the presence of the RFID tag or cell phone to continue the discharge timer. If the user remains long enough for the discharge to reach a pre-established lower limit, the power is turned back on to the laptop by commands from the switching device to the control device to allow uninterrupted work. When the user does leave as noted by the RFID tag or cell phone departure, then the laptop is powered off again (in this case by the control device noting the absence of the Tag) until its designated low cost recharge time when the switching device commands the control device to turn on the power to the laptop.

Adding a properly sized uninterruptable power supply for peripherals such as desk lamps, secondary displays etc., could drop the overall cost of electricity for those devices to zero depending on the rate structure chosen.

Returning now to FIG. 8A, in further embodiments, a manual override may be employed as at block 840, thereby overriding any command from the switching device to change power to one or more of the end devices.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein.

All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) is closed herein is to be understood to set forth every number and range encompassed within the broader range of values.

Also, the terms in the claims have their plain, ordinary meaning unless otherwise explicitly and clearly defined by the patentee. Moreover, the articles “a” or “an,” as used in the claims, are defined herein to mean one or more than one of the element that it introduces. As used herein the term “and/or” and “/” includes any and all combinations of one or more of the associated listed items. While compositions and methods are described in terms of “comprising,” “containing,” or “including” various components or steps, the compositions and methods can also “consist essentially of” or “consist of” the various components and steps.

It will be understood that the sizes and relative orientations of the illustrated elements are not shown to scale, and in some instances they have been reduced or exaggerated for purposes of explanation. Additionally, if there is any conflict in the usages of a word or term in this specification and one or more patent or other documents that may be incorporated herein by reference, the definitions that are consistent with this specification should be adopted.

1. A method for reducing aggregate power cost, the method comprising:
determining an end device power consumption profile for each of a plurality of end devices, wherein said plurality of end devices are electrically coupled to a control device configured to control power flow to said plurality of end devices;
storing said end device power consumption profiles in a switching device configured to determine a desired power flow timing for each of said plurality of end devices, wherein said switching device is communicably coupled to said control device;
determining an optimal rate period with said switching device;
determining, with said switching device, said desired power flow timing for each of said plurality of end devices such that a power consumption of said plurality of end devices is preferably within said optimal rate period; and
controlling, via said control device, said plurality of end devices such that said desired power flow timing is substantially obtained, thereby reducing aggregate cost per kWhr of said plurality of end devices.

2. The method of claim 1, wherein said power consumption profile for each of said plurality of end devices is determined by said control device.

3. The method of claim 1, wherein determining an optimal rate period accounts for at least one of a current peak demand or predicted future peak demand of energy usage.

4. The method of claim 1, wherein determining an optimal rate period accounts for a temporal rate plan.

5. The method of claim 1, further comprising override means for controlling at least one of said plurality of end devices which overrides said switching device.

6. The method of claim 1, wherein determining said desired power flow timing excludes critical end devices of said plurality of end devices.

7. The method of claim 1, further comprising:
associating a user with a user device configured to transmit a unique user device ID; and
determining a user location of said user relative to an effective use range of at least one of said plurality of end devices,
wherein determining said desired power flow timing for each of said plurality of end devices is at least partially based on said user location.

8. The method of claim 7, wherein said user device is an active RFID tag, and wherein said user location is determined via a received signal strength indication (RSSI) received by said control device.

9. A system for reducing aggregate power cost, the system comprising:
a plurality of end devices, each of said plurality of end devices having a power consumption profile;
first means for controlling power flow timing of said plurality of end devices, said first means being electrically coupled to said plurality of end devices; and
a switching device having second means for determining a desired power flow timing for each of said plurality of end devices, said switching device being communicably coupled to said first means and configured for:
storing said end device power consumption profiles; and
determining an optimal rate period,
wherein said second means determines said desired power flow timing such that power consumption of said plurality of end devices is preferentially within said optimal rate period, and
wherein said first means controls power flow timing to said plurality of end devices such that said desired power flow is substantially obtained, thereby reducing aggregate cost per kWhr of said plurality of end devices.

10. The system of claim 9, wherein said power consumption profile for each of said plurality of end devices is determined by said first means.

11. The system of claim 9, wherein determining an optimal rate period accounts for at least one of a current peak demand or predicted future peak demand of energy usage.

12. The system of claim 9, wherein determining an optimal rate period accounts for a temporal rate plan.

13. The system of claim 9, further comprising override means for controlling at least one of said plurality of end devices which overrides said first means.

14. The system of claim 9, wherein said second means for determining said desired power flow timing excludes critical end devices of said plurality of end devices.

15. The system of claim 9, further comprising a user device configured to be associated with a user and transmit a unique user device ID,
wherein a user location of said user is determined relative to an effective use range of at least one of said plurality of end devices, and
wherein said desired power flow timing is further at least partially based on said user location.

16. The system of claim 15, wherein said user device is an active RFID tag, and wherein said user location is determined via a received signal strength indication (RSSI) received by said first control means.
